(19) United States
(12) Patent Application Publication
(10) Pub. No.: US 2014/0101781 A1
(43) Pub. Date: Apr. 10, 2014

(54) PEER-TO-PEER, REAL-TIME, DIGITAL MEDIA DISTRIBUTION

(71) Applicant: SEDRICK ANDREW BOUKNIGHT, DENVER, CO (US)

(72) Inventor: SEDRICK ANDREW BOUKNIGHT, DENVER, CO (US)

(21) Appl. No.: 14/035,273

(22) Filed: Sep. 24, 2013

Related U.S. Application Data
(60) Provisional application No. 61/710,177, filed on Oct. 5, 2012.

(51) Int. Cl. G06F 21/10

(52) U.S. Cl. CPC G06F 21/105
USPC 726/28

(57) ABSTRACT

Systems are provided, including inventive servers configured to eliminate the traditional limitations on the distribution of real-time video/audio/images while at the same time making real-time broadcasting to millions of viewers accessible to anyone with a video/audio/image enabled mobile device and internet connection. At the same time, the same audience of millions can interact in real-time with fellow viewers as the broadcast occurs. This may be done in a secure/controlled way via, in some embodiments, DRM supports.

### RELATED APPLICATION

This application claims priority to provisional patent application U.S. Ser. No. 61/710,177 filed on Oct. 5, 2012, the entire contents of which is herein incorporated by reference.

### BACKGROUND

The embodiments herein relate generally to a system for managing and facilitating peer-to-peer, real-time, digital media distribution, and more specifically to a system that permits a first user to seek out whether a second user is in a geographic position to record an event local to the second user and request that the second user record the event and transmit the recording in streaming format from the second user to the first user.

Conventional approaches to broadcasting do not encompass allowing anyone to capture and securely broadcast events as they occur to an unlimited audience while at the same time permitting the audience to provide immediate interactive feedback or information to the person broadcasting. The feedback or information from the audience further typically does not include sufficient metadata to supplement the discovery of content and characteristics of consuming endpoints with location awareness.

Conventional broadcasting systems impose limits in the distribution of real-time video/audio/images either in the total number of concurrent viewers or concurrent broadcasters. Conventional products require the submission and storage of content for distribution. Once stored, the originator of the content has limited assurance or control in its distribution and typically these conventional systems do not provide any level of DRM-secure control over the content once submitted. Improvements to these conventional approaches to broadcasting are desirable.

### SUMMARY

The system of the present disclosure may eliminate the limitations on the distribution of real-time video/audio/images while at the same time making real-time broadcasting to millions of viewers accessible to anyone with a video/audio/image enabled mobile device and internet connection. At the same time, the same audience of millions can interact in real-time with fellow viewers as the broadcast occurs. This may be done in a secure/controlled way via, in some embodiments, DRM supports.

In one embodiment, a system for managing and facilitating peer-to-peer, real-time, digital media distribution is provided that is configured to permit a first user to seek out whether a second user is in a geographic position to record an event local to the second user and request that the second user record the event and transmit the recording in streaming format from the second user to the first user in real time. In such an embodiment, the system may be configured to be a client-based downloadable application, an installable executable software program, or an on-line web-based service that users may access, where the system comprises a central server configured to permit digital communications between a plurality of users, where the users employ a computerized device to access the central server with either a client-based application or program or via the web-based service, the central server comprising a database of information unique to individual users that enables the server to assess geographic location of the users based upon at least one mobile computerized device of the user, the server being configured to process a first user's request for real-time digital media content where the request seeks real-time digital content about a remote event occurring or soon to occur from at least one second user who the system server has determined may be in geographic proximity to the event to obtain such real-time digital content about the event, where such digital content comprises a video recording, an audio recording, an image recording, and/or a text description about the event responsive to the first user's request, the server configured to permit transmission of real-time digital media content about a requested event directly from at least one second user to the first user where the at least one second user has been notified of the request of the first user for such real-time digital media content about the event, the server further configured to permit the exchange of real-time digital content for later distribution to other users who submit the same or similar request for real-time digital media content about the event, where the transmission can be sent either from the at least one second user, a different second user, or from the first user once the first user has received the requested real-time digital media content, the server being further configured to store the real-time digital media content in encrypted form if any user transmitting such real-time digital media content elects to encrypt such real-time digital media content for transmission so that transmission and/or distribution of such real-time digital media content is limited to authorized users of the system, particularly where such real-time digital media content may be subject to digital media rights licensing restrictions, the server further configured to transmit a notice to users that real-time digital media content about an event is available where such users desire to access such real-time digital media content about the event.

In some embodiments, the server is further configured to broadcast at least some of the real-time digital media content obtained by one or more users through the cloud accessible by other users where such users request such content or are notified by the server that such content is available. In the same or other embodiments, the system is configured to restrict user access to those who have subscribed to or enrolled with the system and/or the system is configured to restrict user access to users based upon structured criteria such as geographic location or the number of permissible playbacks of the user generated real-time digital media content. In some applications, the system is configured to permit one user within the multi-level distribution network to be substituted with another user almost instantaneously as soon as the one user drops off of the distribution network, where the another user may be already within the multi-level distribution network but at a lower level or may be a new entrant into the multi-level distribution network. Preferably, the systems include digital right management features to restrict the transmission of certain content as appropriate.

In an alternative embodiment, a system is provided for managing and facilitating peer-to-peer, real-time, digital media distribution that is configured to function as a user request clearinghouse for on-demand user-originating content that is brokered and routed to capable candidates based on structured criteria, where such structured criteria is inclusive of subject matter content, geographic location, date/time, and other applicable discriminating criteria, including the number of permissible playbacks of the user generated real-time digital media content. In such embodiments, the system comprises a central server configured to permit digital communications between a plurality of users, where the users employ a computerized device to access the central server, the server being configured to process a first user's submission of real-time digital media content about an event occurring in which other users may be interested, where such digital content comprises a video recording, an audio recording, an image recording, and/or a text description about the event, the server configured to permit transmission of real-time digital media content about an event directly from the first user to at least one second user where the at least one second user has been notified of the availability of such real-time digital media content about the event, where the transmission can be sent from the first user to either one second user or a plurality of other users, or from the one second user or one of the plurality of other users to yet additional users in an exponentially scaling fashion, the server further configured to transmit a notice to users that real-time digital media content about an event is available where such users desire to access such real-time digital media content about the event.

In some embodiments, the system is configured to be either a client-based downloadable application, an installable executable software program, or an on-line web-based service that users may access, and or wherein the system is configured to permit the first user to restrict access by other users based upon the structured criteria. If so desired, the system embodiments may be configured to store real-time digital media content at external locations and devices not under the full control of the content originator or content consumer, including cloud-based storage provider repositories.

### BRIEF DESCRIPTION OF THE FIGURES

The detailed description of some embodiments of the invention will be made below with reference to the accompanying figures, wherein like numerals represent corresponding parts of the figures.

FIG. 1 is a schematic diagram of a first embodiment of a broadcast system according to the present disclosure where multiple users access and consume telemetry and then generate and broadcast multiple data feeds.

FIG. 2 is a schematic diagram of a second embodiment of a broadcast system according to the present disclosure, where a requestor sends a request for particular broadcast stream and a broadcaster produces a data stream on demand.

FIG. 3 is a schematic diagram of a third embodiment of a broadcast system according to the present disclosure, where a user creates a data feed and then stores the data feed in the cloud for later access using encryption keys stored by a central services provider.

FIG. 4 is a schematic diagram of a fourth embodiment of a broadcast system according to the present disclosure, where a broadcaster creates and sends a data feed to a viewer who then records the data feed in the cloud with an encryption key for accessing the data being stored by a central services provider.

FIG. 5 is a schematic diagram of a fifth embodiment of a broadcast system according to the present disclosure, where content producer creates and distributes content to a content consumer who must access a license controlled by a central services provider to be able to consume the content in its original format.

FIG. 6 is a schematic diagram of a sixth embodiment of a broadcast system according to the present disclosure, where a number of different content creation and consuming devices may be in an interconnected network distributing content to a variety of users.

### DETAILED DESCRIPTION OF CERTAIN EMBODIMENTS

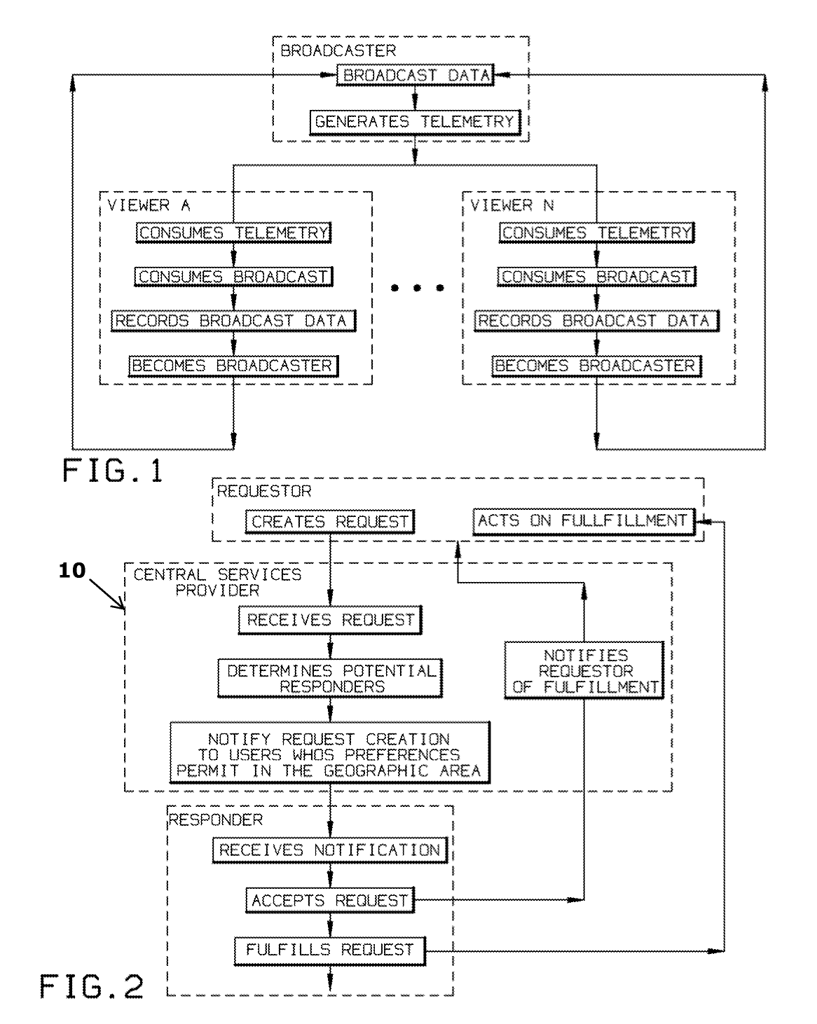

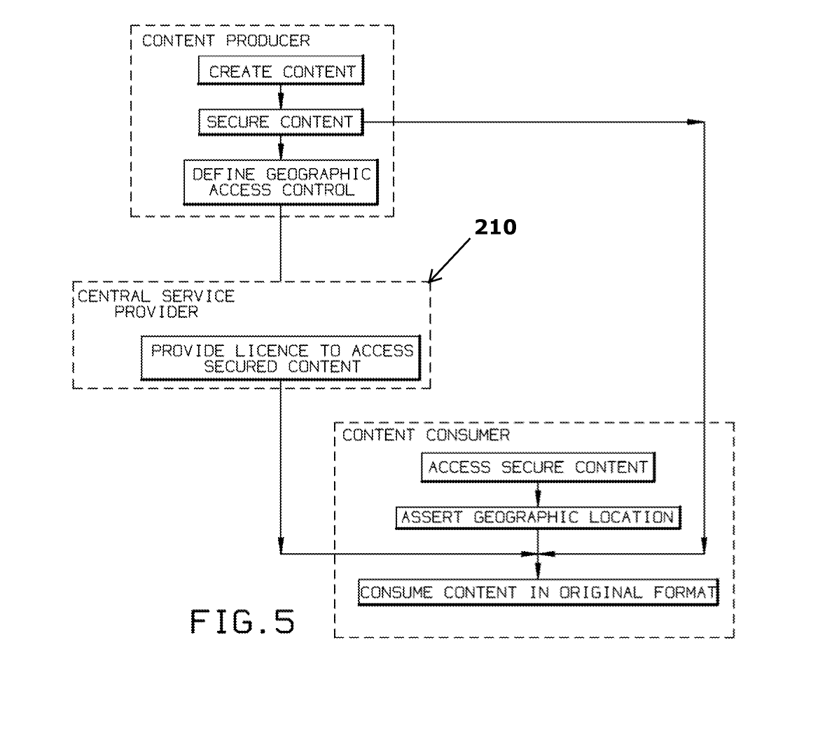

Embodiments of the present invention address the problem of securely broadcasting real-time video, by anyone, of contemporaneous events to an unlimited audience while at the same time receiving immediate interactive information from the audience with the necessary metadata to supplement the discovery of content and characteristics of consuming endpoints with location awareness. In that regard, certain embodiments are configured to create a potentially unlimited (exponential) peer-to-peer network that is coordinated by a central system or central services provider. In this example of an inventive peer-to-peer network, each node (i.e., user with a computerized device) can receive, display, and relay the real-time video/audio/images broadcast to one or multiple other nodes (users) thus allowing a near infinite distribution, as reflected generally in FIGS. 1 through 6.

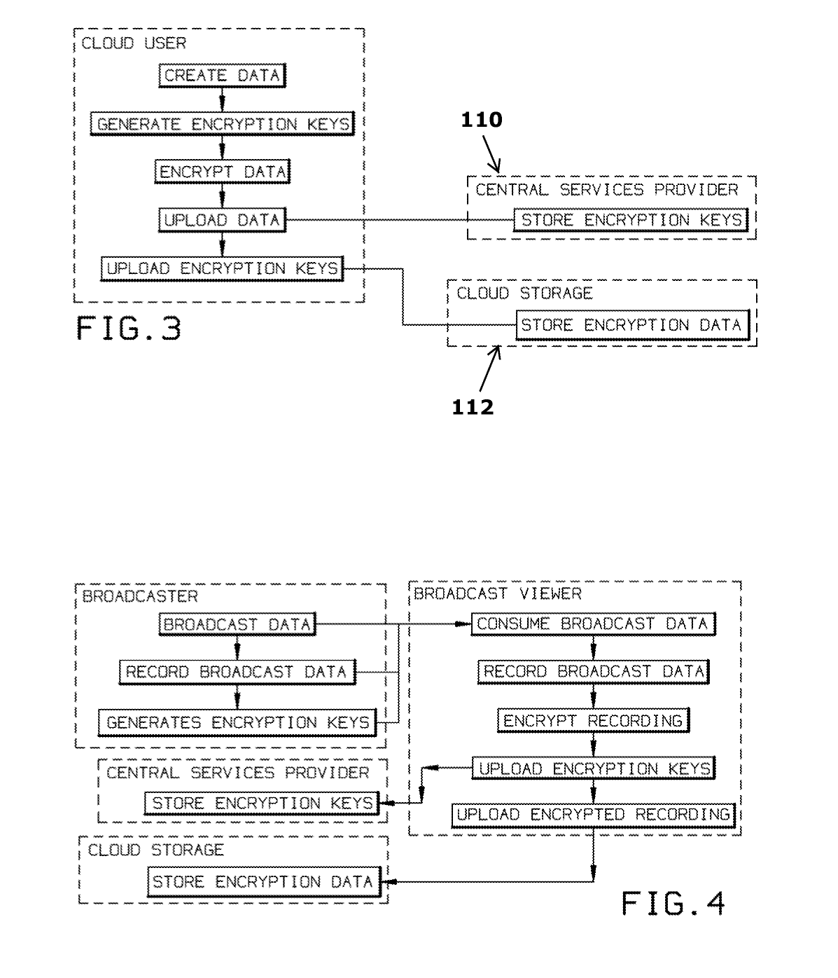

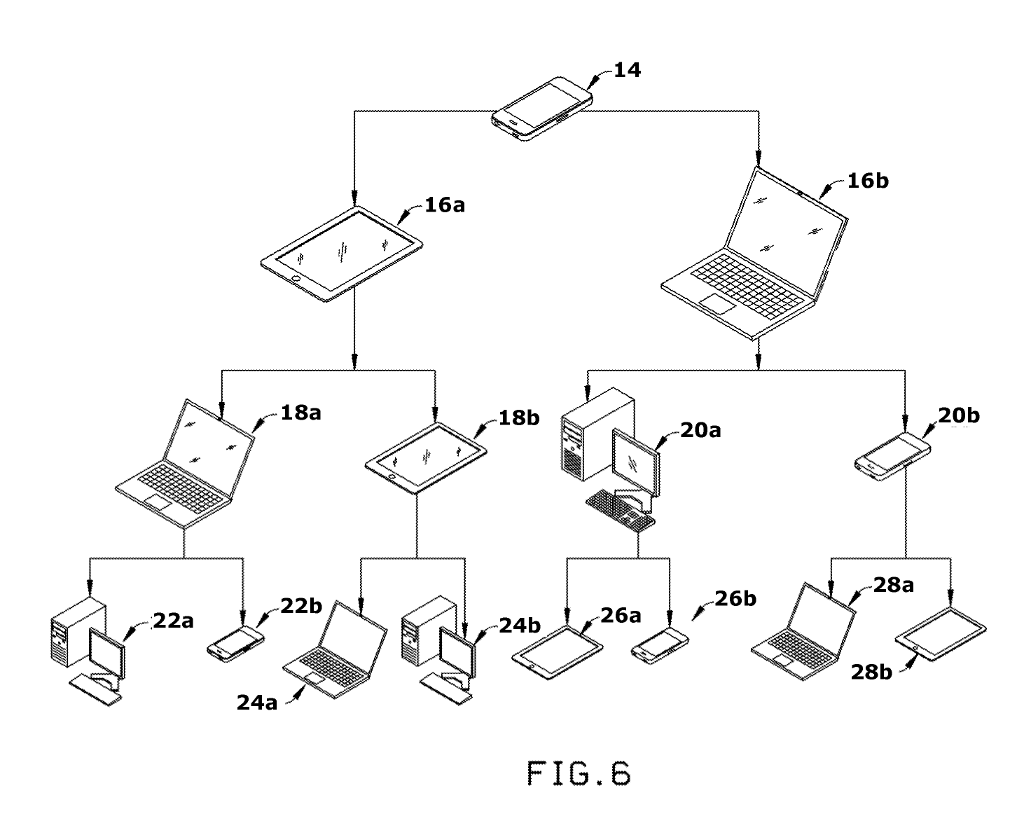

In certain applications, the broadcasting and receiving/relaying nodes (see FIG. 6) can form an ad-hoc mesh in which additional information and telemetry, including node geo-location data, can be transmitted. Preferably, referring to FIG. 2, a central coordinating system 10 (i.e., a central server) accessible to users through a downloadable application, an installable software program, or a web-based interface, may provide cryptographic supports such that the broadcast video/audio/images and non-video/audio/images information is secured by a digital rights management layer. In some embodiments, and with reference to FIG. 3, a server 110 may function as storage of content, but in other embodiments, cloud storage 112 may added and/or substituted for the memory of the central server. This will permit a creator or generator of data within the system to store data for later retrieval and, if so desired, control who can see the data they supply into the system. In that regard, the protections of digital rights may be a feature in embodiments of the invention, where a server 210 is configured to address digital rights, as shown by example in FIG. 5. In other words, certain embodiments may provide for secure some or all exchanged video/audio/images and data to be exchanged with digital rights management measures in place.

Embodiments of the present invention differ from what currently exists because the embodiments are configured to permit the broadcast of live video/audio/images and data from a mobile device, including such devices as a smart phone, PDA, tablet or notebook, by a nearly unlimited number of concurrent broadcasters to a nearly unlimited number of concurrent viewers, as reflected by example in FIG. 6. In certain embodiments, the system is configured to allow some or all of the participating audience to contemporaneously exchange information, in real-time, with other audience members, including the one or more broadcasters.

Using one example of an embodiment and an exemplary application thereof, great understanding of the invention may be appreciated. In such example, a central services provider may expose a set of internet-accessible web services to allow the authentication of users, registration of user devices, and coordination of devices to establish ad-hoc device networks to distribute real-time media content broadcasts with digitally rights managed protection through user broadcast channels to other users as viewers for consumption. Access to media broadcasts and the ability to broadcast may be predicated on the existence of a user account. The existence of a user account may represent a user that can view media content, broadcast media content, and interact with other users by transmitting and or receiving information.

A user identity may be a set of discrete information used to uniquely and thoroughly define a singular specific user such that subsequent operations that require authorization or privilege can be executed upon verification. A device may be a physical entity comprised of electronic instruments capable of receiving, transferring, processing, and interpreting any of the above transmitted information. A device identity may be a set of discrete information used to uniquely and thoroughly define as well as distinguish a singular device to permit operations that require coordination or cooperation can be executed within the context of a user session.

Such a session may be a period of user activity on a specific device that commences with user authentication to produce a verification token and continues until terminated by the user or until an inactivity criteria is reached. A media broadcast may be the transmission and relay of media content by a user through an interconnection of devices that form an integrated mesh dedicated to the distribution of the content and consumption of the content on the devices within the mesh. A user broadcast channel may be a mechanism to define, classify, organize, categorize, and schedule broadcasting based on topic, theme, focus, or genre.

A subscription may be a notification and participation facilitator that allows the definition of search query or selection of content, broadcasts, users, or channels. Users create and manage subscriptions. Subscriptions provide a quantitative metric in expressing content ratings (ranking) A content schedule may be a means to set intended dates/times for which broadcasts will occur. Content scheduling may catalyze the formation of the content distribution network.

Based on allowed digital rights management privileges, users may be able to capture a media stream broadcast for later review. This may be achieved by a media stream recorder. The media stream recorder may store the media stream encrypted against a composite key as protected media to a device storage resource or a remote storage resource repository. The DRM key that may be used during capture may be derived from the combination of the authentication token, user ID data, device ID data, and the actual broadcast.

In operation, the system according to the present disclosure may function and be constructed as follows in an exemplary configuration: the system may be comprised of a central data store, services to access the data store, services to perform computations/actions against the data store, and devices that consume these services such that devices may connect directly to one another to transmit, relay, receive, and capture data. This configuration may allow a user with a media capture device, which is capable of connecting to other devices, to generate content and broadcast that content (real-time). The structure may be a centrally-assisted peer-to-peer network in which discovery and exchange is facilitated by a central services provider. The generated ad-hoc networks may be structured such that a content stream may be generated from one node and then relayed to an unlimited number of subordinate consuming/relaying nodes, as shown in FIG. 6.

A central data store may hold data for various divisions that may include but are not limited to: system, object (user/device/session), content, info, node, security, community, points, and integration support. Each of these primary divisions may constitute a schema. To create the central data store, it may be desirable to establish one or more schemas and database elements therein. For example, a system schema may comprises global parameters, configuration values, and monitoring, administration, and diagnostic supports. An object(s) schema may comprise users, devices, and sessions, while a content schema may comprise broadcasts, channels, subscriptions, schedules, and repositories. Embodiments may also comprise info schema that may comprise request objectives, telemetry data, and meta data, while a security schema may include user-level cryptographic data, device-level cryptographic data, DRM privilege data, and DRM key data. Embodiments may also comprise a nodes Schema, which may comprise nodes, node connections, node attributes, and node aggregate statistics, while a community schema may comprise communities, community guards, community managers, community notices, community actions, and community votes. The same or other embodiments may further comprises a points and exchange schema, which may comprise user points, points transactions, and ratings transactions, while an integration support schema may comprise user external identities, external systems, and user signal sign-on.

As preconditions in certain embodiments, the central services provider (10, 110, or 210), devices (nodes), and users may be established. All participating users would preferably be authenticated through the central service provider on his or her individual device. Upon authentication, the user device attributes may be conveyed to the central services provider. In an exemplary application, and referring to FIG. 6, User 14 may begin a broadcast. Users 16a, 16b, 18a, 18b, 20a, and 20b may search for active broadcasts and select the broadcast originating from user 14. The device attributes of User 14 device may be transmitted to the devices of the other users as a result of broadcast selection. All devices of the various Users may then attempt to connect to User 14 device. The User 14 device may establish a connection with Users 16a and 16b. User 14 may direct Users 18a and 18b to connect to User 16a. User 14 may also direct Users 20a and 20b to connect to User 16b. A mesh may, thus, be formed between Users 14, 16a, 16b, 18a, 18b, 20a, and 20b. User 14 may then produce media content and simultaneously transmit the stream to Users 16a and 16b. User 16a may then simultaneously re-transmit the stream to Users 18a and 18b. User 16b may then simultaneously re-transmit the stream to Users 20a and 20b. Users 18a, 18b, 20a and 20b may then be capable to further re-transmit the stream to up to eight or more different devices, including Users 22a-b, 24a-b, 26a-b and 28a-b, although in other embodiments, each User may transmit to only one or more than two downstream Users. Those eight User devices may then be capable to further re-transmit the stream to further downstream devices. The process may continue until all interested consumers are receiving the media stream generated initially by User 14. Telemetry generated in a node may also be transferred to the nearest nodes and subsequently relayed. Telemetry data that has already been relayed by a node may typically not be re-transmitted. Telemetry data is typically or preferably only relayed for a discrete timeframe or time to live.

To construct the system of the present disclosure, a variety of software components may be constructed to both compose the central services provider and the respective devices that constitute nodes to achieve the system functionality. The central services provider software may be established by creating structured data storage, unstructured data storage, data access layers, data model abstraction layers, data utility modules, application services foundations, service data messaging structures, remote service endpoint exposures, computational modules, security modules, diagnostic instrumentation, communication adapters, and external systems' integration suites.

Device software may be established by creating structured data storage, unstructured data storage, data access layers, data model abstraction layers, data model behavioral aspects, data utility modules, computational modules, security modules, diagnostic instrumentation, communication adapters, external systems' integration suites, sensor adapters, sensor controllers, device controllers, device event handlers, device interaction abstractions, user experience modules, user interface modules, and telemetry capture adapters.

These components are typically required for core functionality of a system according to the present disclosure, excluding the external systems' integration suites. A module to allow monetary transactions between users based on constrained and unconstrained activities could be used to further improve the functionality and capabilities of the system. A module to allow synchronous and asynchronous real-time and non-real-time messaging between users based on constrained and unconstrained preferences could be used to further improve the functionality of the system. Artifacts, features, and characteristics that yield greater activity improve the system in such that system capacity may be directly dependent on aggregate activity. System components can be interchanged such that the physical layers and logical tiers can be further divided individually or merged in combination to fulfill the underlying functional capabilities.

In another application of an embodiment of the present disclosure, a broadcasting user may access the system through a device. The broadcasting user may provide credentials in which he or she is identified within the system. On the device, the broadcasting user may be presented with an interface for system interaction. Through the interface, the broadcasting user may then initiate a broadcast. For this broadcast, some metadata may be resolved automatically. The broadcasting user may be prompted to provide additional metadata as he or she desires. The broadcasting user may also be prompted to define, if desired, the consumption restrictions on the broadcast media contents. Based on the device capabilities, the broadcasting user may dictate the capture mechanisms for the broadcast's media. The broadcasting user may then commence media capture and the broadcast becomes active. The broadcast information, including metadata and supplemental information, may be conveyed such that consumption by other users can begin. Furthermore, based on the metadata and supplemental information, notification of the active broadcast may be conveyed through one or more various channels.

A viewing user may access the system through a device. The viewing user provides credentials in which he or she is identified within the system. On the device, the viewing user may be presented with an interface for system interaction. The viewing user may be provided with a listing of active broadcasts that fulfill criteria that have been previously defined by the viewing user or interpolated through the viewing user's prior activity as suitable. Through the interface, the viewing user may search for active broadcasts based on a metadata or supplemental information criteria query. A list of active broadcasts that fulfill the criteria (limited to those permitted for consumption based on constraints) may be presented to the viewing user. The viewing user may then selects an active broadcast and consumption of the broadcast media may begin. The broadcast media content may be rendered on the device according to the content (video/audio/image/other) and according to the device capabilities.

Embodiments of the present invention may be configured to be applicable to a broader set of applications than those described above, including for example: mobile/portable device video camera networks, mobile media relay production systems, smart grid controls system, conventional media broadcast via extended field presence, military application including intelligence gathering or espionage, security application including civil defense, law enforcement and emergency response support, medical application for both data acquisition and telemedicine as well as composites, signal/sensory mapping through telemetry generation and relay, intelligent traffic systems data gathering, including commuter transit routing, intelligence gathering, automation (inverted command and control), location-based advertising, entertainment/gaming, including location-aware scavenger hunts, objective and incentive based advertising, objective request, location aware, amber alert supplements (real time media capture), infrastructure-less, private, secured, decentralized, and open nebulous social network, and cloud storage security.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. A system for managing and facilitating peer-to-peer, real-time, digital media distribution that is configured to permit a first user to seek out whether a second user is in a geographic position to record an event local to the second user and request that the second user record the event and transmit the recording in streaming format from the second user to the first user in real time, the system being configured to be a client-based downloadable application, an installable executable software program, or an on-line web-based service that users may access, the system comprising:
a central server configured to permit digital communications between a plurality of users, where the users employ a computerized device to access the central server with either a client-based application or program or via the web-based service, the central server comprising a database of information unique to individual users that enables the server to assess geographic location of the users based upon at least one mobile computerized device of the user, the server being configured to process a first user's request for real-time digital media content where the request seeks real-time digital content about a remote event occurring or soon to occur from at least one second user who the system server has determined may be in geographic proximity to the event to obtain such real-time digital content about the event, where such digital content comprises a video recording, an audio recording, an image recording, and/or a text description about the event responsive to the first user's request, the server configured to permit transmission of real-time digital media content about a requested event directly from at least one second user to the first user where the at least one second user has been notified of the request of the first user for such real-time digital media content about the event, the server further configured to permit the exchange of real-time digital content for later distribution to other users who submit the same or similar request for real-time digital media content about the event, where the transmission can be sent either from the at least one second user, a different second user, or from the first user once the first user has received the requested real-time digital media content, the server being further configured to store the real-time digital media content in encrypted form if any user transmitting such real-time digital media content elects to encrypt such real-time digital media content for transmission so that transmission and/or distribution of such real-time digital media content is limited to authorized users of the system, particularly where such real-time digital media content may be subject to digital media rights licensing restrictions, the server further configured to transmit a notice to users that real-time digital media content about an event is available where such users desire to access such real-time digital media content about the event.

2. The system of claim 1, wherein the server is further configured to broadcast at least some of the real-time digital media content obtained by one or more users through the cloud accessible by other users where such users request such content or are notified by the server that such content is available.

3. The system of claim 1, wherein the system is configured to restrict user access to those who have subscribed to or enrolled with the system.

4. The system of claim 1, wherein the system is configured to restrict user access to users based upon structured criteria such as geographic location or the number of permissible playbacks of the user generated real-time digital media content.

5. The system of claim 1, wherein the system is configured to permit the creation of a multi-level distribution network for the transmission of the real-time digital media content about an event to a plurality of users in an exponentially scaling fashion without overloading the transmission capability of any one user's computerized device dependent upon the available bandwidth and/or other transmission restrictions of such computerized device.

6. The system of claim 4, wherein the system is configured to permit one user within the multi-level distribution network to be substituted with another user almost instantaneously as soon as the one user drops off of the distribution network, where the another user may be already within the multi-level distribution network but at a lower level or may be a new entrant into the multi-level distribution network.

7. The system of claim 4, wherein the system is configured to permit peer-to-peer transmission of real-time digital media content about an event to an unlimited number of users within the multi-level distribution network.

8. A system for managing and facilitating peer-to-peer, real-time, digital media distribution that is configured to function as a user request clearinghouse for on-demand user-originating content that is brokered and routed to capable candidates based on structured criteria, where such structured criteria is inclusive of subject matter content, geographic location, date/time, and other applicable discriminating criteria, including the number of permissible playbacks of the user generated real-time digital media content, the system comprising:
a central server configured to permit digital communications between a plurality of users, where the users employ a computerized device to access the central server, the server being configured to process a first user's submission of real-time digital media content about an event occurring in which other users may be interested, where such digital content comprises a video recording, an audio recording, an image recording, and/or a text description about the event, the server configured to permit transmission of real-time digital media content about an event directly from the first user to at least one second user where the at least one second user has been notified of the availability of such real-time digital media content about the event, where the transmission can be sent from the first user to either one second user or a plurality of other users, or from the one second user or one of the plurality of other users to yet additional users in an exponentially scaling fashion, the server further configured to transmit a notice to users that real-time digital media content about an event is available where such users desire to access such real-time digital media content about the event.

9. The system of claim 8, wherein the system is configured to be either a client-based downloadable application, an installable executable software program, or an on-line web-based service that users may access.

10. The system of claim 8, wherein the system is configured to permit the first user to restrict access by other users based upon the structured criteria.

11. The system of claim 8, wherein the system is further configured to store real-time digital media content at external locations and devices not under the full control of the content originator or content consumer, including cloud-based storage provider repositories.
